(19) United States
(12) Patent Application Publication
(10) Pub. No.: US 2002/0011498 A1
(43) Pub. Date: Jan. 31, 2002

(54) MANUFACTURED POUR SPOUT FITMENT AND CONTAINER

(76) Inventors: EDWARD JOHN GIBLIN, HOPATCONG, NJ (US); GREGORY ALAN LATHROP, SOUTHBURY, CT (US)

Correspondence Address: UNILEVER, PATENT DEPARTMENT, 45 RIVER ROAD, EDGEWATER, NJ, 07020, US

(21) Appl. No.: 09/224,229

(22) Filed: Dec. 30, 1998

(51) Int. Cl. B67D 1/16

(52) U.S. Cl. 222/109; 222/111; 222/571

(57) ABSTRACT

A spout, especially suitable for a heavy duty liquid detergent container fitment, is made by thermoforming. Preferably the spout is part of a fitment which includes a bottom wall extending from the bottom of the spout wall, a circumscribing wall surrounding the spout and extending from the bottom of the bottom wall and a peripheral radially extending flange extending from the top of the circumscribing wall. The thermoformed spout/fitment finds special use in plastic containers having inside blown threads. The inside blown threads mate with external threads on a closure.

### BACKGROUND 0F THE INVENTION

Consumers have grown increasingly to prefer laundry detergents in the form of liquids. Thus, the need is as great as ever for a convenient container for dispensing such products, yet which is also easier and less costly to manufacture than current versions. Such containers preferably include a combination pour spout/drainback fitment and a closure which also serves as a measuring cup. Numerous dispensers have been disclosed in the patent literature.

Bengtsson, U.S. Pat. No. 5,498,149 discloses a device for thermoforming a pouring spout.

Greehow et al., U.S. Pat. No. 4,111,340 discloses a pouring spout for threaded neck containers. At least portions may be thermoformed.

Malmberg, U.S. Pat. No. 5,564,603 discloses a thermoformed pour spout.

Christian, U.S. Pat. No. 3,895,743 discloses a lid including a pour spout. Preferably, the closures are vacuum thermoformed.

Reid, U.S. Pat. No. 5,603,787 discloses a plastic container for pourable liquids such as detergents which has a drainback feature. The container is formed in two pieces, a container body and a separately formed pour spout which is assembled to the container finish preferably by ultrasonic welding. A lip of the pour spout component is pressed and welded down onto an annular top surface of the container finish. The pour spout component includes internal threads which mate with external threads on the closure, which also serves as a measuring cup.

Reidel, U.S. Pat. No. 5,598,877 is directed to a liquid dispenser having a botcher with a holder.

Leahy, U.S. Pat. No. 5,597,090 is directed to an apparatus for pouring liquids which includes a cap having internal threads mated with external threads on the container finish, and a fitment which has a flange 39 which mates with the open end of the container at the neck.

Haffner et al., U.S. Pat. No. 5,566,862 is directed to a liquid dispensing fitment for use on a container. The container finish includes external threads which mate with internal threads on a closure. The fitment includes a peripheral flange adapted to engaged the upper surface of the neck.

Haffner et al., U.S. Pat. No. 5,462,202 discloses a liquid dispensing fitment for use on a container having a neck. The finish of the container includes external threads which mate with internal threads on a closure. The fitment includes a flange adapted to engage the upper surface. The fitment includes vertical ribs which are said to facilitate stacking of the fitments.

Ekkert et al., U.S. Pat. No. 5,435,467 discloses a pouring spout configured to permit orientation-specific stacking. A container is illustrated having an externally threaded finish mating with an internally threaded closure. A peripheral flange on the fitment fits atop the neck of the finish.

Reid, U.S. Pat. No. 5,431,306 discloses a fitment having internal threads and a flange which rests on the upper edge of the container finish.

Krall, U.S. Pat. No. 5,429,789 discloses a self-draining container. Located within an annular wall is a spout. A closure include a skirt which has external threads which engage the internal threads of the annular wall. Extending radially outwardly from the skirt of the closure above the threads is a ledge adapted to seat against the top of the annular wall to seal the container when the threads are fully engaged.

Adams et al., U.S. Pat. No. 5,303,837 discloses a tamper evident device which comprises a fitment attached around an aperture in a container and having a flange from which extends an internally threaded spout. The spout is closed by an initially integrally molded externally threaded plug.

Krall, U.S. Pat. No. 5,207,356 discloses a self draining container including an integral dispensing spout. An integral wall extends upwardly from the body and encircles the spout and an integral web joins the wail on the dispensing spout to form a drain channel. A cap having a depending skirt with external threads mates with an internal thread on the container wall. The cap also includes a radially outwardly extending sealing ring.

Meyer et al., U.S. Pat. No. 4,929,410 discloses a closure with external threads and a shoulder and, in FIG. 8, an internally threaded neck of a plastic bottle in which a pouring adapter insert has been mounted. It is said that the details of the pouring adapter and of the internal attachment means may be varied, but FIGS. 7 and 8 illustrate the pouring adapter insert as having a snap flange designed to fit within a groove of the internal attachment means.

Yeager, U.S. Pat. No. 5,207,341 discloses a container which includes a closure having a concentric inner skirt and outer skirt, the outer skirt covering and protecting the outer circumference area of the bottle neck thereby protecting it from the environment outside the bottle.

Bavegems, U.S. Pat. No. 5,131,566 is directed to a package for flowable products incorporating a refill facilitating pouring spout structure. Internal screw threads on the pouring spout structure mate with external screw threads on the package.

Krall, U.S. Pat. No. 5,114,659 discloses a self draining container. The container includes a body having a wall extending upwardly from a body opening. The wall surrounds a dispensing spout. A web joins the wall on the dispensing spout to form a drain channel. A closure has a depending skirt having external threads which mate with internal threads on the wall. The closure also includes an outwardly extending radial sealing ring.

Segati, U.S. Pat. No. 5,060,827 relates to a low profile closure which includes a coupling member which is mounted on a container dispensing opening. The coupling member includes a top peripheral edge which defines an outwardly projecting spout. The cap has external threads which mate with internal threads on the coupling member.

Darr, U.S. Pat. No. 5,020,692 discloses a container having a unitary plastic blow-molded bottle which has a dispensing spout projecting upwardly from a hollow body portion. In one embodiment, an annular insert surrounds the spout and has internal retainers which secure external retainers on the cap to provide sealing. The cap also includes a round sealing surface that faces downwardly in alignment with a round sealing surface on the annular insert.

Krall, U.S. Pat. No. 4,989,757 discloses a self draining container having a dispensing spout and a wall surrounding the dispensing spout. A web joins the wall on the dispensing spout to form a drain channel. A closure has a depending skirt with external threads which mate with internal threads on the container wall. The closure also includes a ledge adapted to seat against the top of the annular wall.

Cappel et al., U.S. Pat. No. 4,981,239 is directed to a container for liquids which comprises a closure having external threads which mate with internal attachment means on an annular skirt. The skirt includes means for attachment to the container. The lower end of a fluid retaining means, which includes a spout, is fused to the container in a liquid tight relation.

Fuchs et al., U.S. Pat. No. 4,917,269 discloses a container having a neck with an upwardly extending integral dispensing spout, an integral web extending radially outwardly from the lower end of the dispensing spout and a cylindrical wall spaced radially outwardly of the spout and encircling the spout. The cylindrical wall has an internal thread and a closure has external threads which mate with the internal threads. The closure includes an annular flexible sealing ring above the threads which engages an inner surface of the cylindrical wall and flexes upwardly to provide a seal. A sealing ring above the annular flexible sealing ring extends radially outwardly on the closure and engages the top of the cylindrical wall when the closure is threaded onto the container.

Robinson, U.S. Pat. No. 4,890,768 is directed to a self draining container having a body and an upper integral pouring spout. A ring member is attached to and surrounds the pouring spout. The ring member includes internal threads which mate with threads on a closure.

Fomby, U.S. Pat. No. 4,711,365 discloses a container having internal threads which mate with external threads on a closure. As the closure member is twisted to engage the threads of the container, an annular face of the container rim engages a complementarily configured annular recess in the closure member.

Muckenfuhs et al., U.S. Pat. No. 4,696,416 discloses a container having a finish with external threads, a transition collar including a pour spout having internal threads for mating with the external threads of the bottle finish, the transition collar also including internal threads for mating with external threads of a closure. The closure also includes a shoulder projecting outwardly and providing a sealing surface adapted to contact a sealing ring on an upper surface of the circumscribing wall of the collar.

Reiber et al., U.S. Pat. No. 4,671,421 discloses a plastic container having an insert positioned in the finish. The insert has internal threads for receiving a closure which has external threads. The closure also includes a peripheral flange sealingly engaging the free end of the finish. The insert includes a pour spout. The insert may be placed in position while the finish is hot and when the finish is cooled it shrinks into sealing engagement with the insert. Alternatively, the insert may be spin welded into sealing engagement with the finish. Another option is the use of an adhesive. The spout may be supported by a groove of the insert. In another embodiment the insert has a spout integrally formed within.

St Clair, U.S. Pat. No. 4,640,855 discloses a plastic container with an integral spout. An inner wall of the container neck includes internal threads. The internal threads can receive a threaded closure for closing the package.

Barker et al., U.S. Pat. No. 4,550,862 discloses a package similar to that disclosed in the Muchenfuhs patent mentioned above.

Beckerer, Jr., U.S. Pat. No. 4,280,434 discloses a threaded access cover plate construction for boat decks.

Rausing, U.S. Pat. No. 3,935,968 discloses a container having a threaded neck closed by an externally threaded plug.

Gundel, U.S. Pat. No. 3,391,838 discloses a container said to have anti drip means. A closure has external threads mating with internal threads on the container. The closure also includes an upper umbrella-like concave wall provided to engage and seal the upper edge of the bottle including the pouring spout.

Payson et al., U.S. Pat. No. 3,017,047 discloses a combination vacuum bottle and closure means.

Moy, U.S. Pat. No. 2,549,225 is directed to a non-drip dispensing bottle stopper having external threads mating with internal threads on a bottle.

Kanzaki, U.S. Pat. No. 2,341,102 discloses a bottle having a cap with external threads which cooperate with internal threads on the bottle.

Duffy, U.S. Pat. No. 2,019,402 discloses a bottle having internal and external threads mating with the internal and external threads of a cap.

Grunberg, U.S. Pat. No. 1,617,842 discloses a perfume bottle having internal threads mating with the external threads of a cap.

Tofting, U.S. Pat. No. 1,415,908 is directed to a jar having internal threads mating with external threads on a closure.

Spooner, U.S. Pat. No. 1,351,496 is directed to jar closures having threads mating with those on jars.

Warren, U.S. Pat. No. 1,014,427 is directed to a bottle stopper which has external threads mating with internal threads on the bottle.

Taylor, U.S. Pat. No. 328,533 is directed to a bottle having internal threads mating with external threads on a stopper.

### SUMMARY OF THE INVENTION

In accordance with the invention, a fitment having a circumscribing wall, a floor leading inwardly from the wall and a pour spout ascending from said floor is advantageously made by thermoforming. In particular, a bottle with blown inside threads advantageously utilizes a thermoformed spout of the above type.

There are many advantages to the use of a thermoformed spout, including substantially reduced costs, and the possibility of a transparent spout, which would permit an unobstructed view inside the bottle so that a consumer can easily see when it is time to purchase more. In addition, thermoforming facilitates the manufacture of a horizontal anti-drip lip on the spout in the direction of pour and offers the opportunity to widen the anti-drip lip so that a U-shaped notch can be added to control pour onto stains. Moreover, the spout can be made with a larger curved radius so that almost 100% of the liquid contents can be dispensed. Additionally, it is believed that a thermoformed spout would enjoy faster production cycles. And, its significantly lower part weight should result in a much lower piece price.

Preferably, the thermoformed fitment is used in a container which includes a neck having an inwardly extending ridge and/or wall suitable for retaining the fitment and a finish extending above the ridge and having internal fasteners. Preferably the inwardly extending ridge and/or wall is/are annular. The internal fasteners of the finish are adapted to cooperate with external fasteners on a closure. The closure is preferably suitable to serve also as a measuring cup.

Externally threaded closures are perceived by some to permit cleaner dispensing of product than internally threaded closures. Advantageously, the fitment includes both a pour spout and drainage area which facilitates drainback of unused product into the container. The use of external fasteners on the closure in conjunction with internal fasteners in the finish also facilitates drainback from the closure.

In accordance with another particularly preferred feature of the invention, a fitment-retaining structure on the bottle finish comprising the inwardly extending ridge extends solely below and lateral to the flange, which can be expected to facilitate insertion of the flange.

The fitment of the invention may have a height of its outer wall which is reduced as compared to that of some previous fitments.

The fitment of the invention preferably includes a peripheral flange which, when the fitment is in place in the bottle, is disposed on or above a shoulder above the inwardly extending ridge of the neck. Preferably, the fitment is friction fit within the inwardly extending ridge of the container neck and/or the flange of the fitment is friction fit within the inwardly extending wall.

The fitment of the invention preferably has a circumscribing wall which desirably extends downwardly from the fitment flange, a floor extending inwardly and downwardly from the circumscribing wall and sloping toward a product exit opening in the floor and a spout extending upwardly from the floor. The closure includes outer threads which mate with the inner threads of the container finish. Preferably, above the outer threads is a horizontal flexible radially, outwardly extending flange which helps provide a seal when the closure is threaded onto the container finish. Also, the closure preferably includes a peripheral shoulder above the external fasteners and above the flexible flange, which shoulder is imposed against a top surface of the bottle finish when the closure is in a closed position. Alternatively, the bottle land could be internally beveled and the tapered edge could seal directly on the underside of the closure.

The bottle can be prepared by blowing on the inside wall of a bottle neck finish a continuous thread which is capable of mating with the externally threaded closure. The internal threads also could be formed by a secondary operation immediately after blow molding. An example would be a hot, “reaming/forming” metal form that is screwed into the bottle neck.

The thermoformed spout of the invention also could be used with a bottle that has outside threads as long as the internal ridge inside the bottle neck which stops the spout from being pushed in too far is low enough so that there is no closure contact with the spout.

For a more complete understanding of the above and other features and advantages of the invention, reference should be made to the following detailed description of the preferred embodiments and to the accompanying drawings.

### BRIEF DESCRIPTION OF THE DRAWINGS

FIG. 1 is a side, partial elevational view of the package of the invention showing the closure in the open position and showing the bottle in cross section.

FIG. 2 is a top elevational view of the fitment of the invention.

FIG. 3 is a view of an alternative finish similar to that of FIG. 1 with the rest of the container omitted.

FIG. 4 is a view similar to FIG. 1 showing an alternate embodiment.

### DETAILED DESCRIPTION OF THE INVENTION

Package 10 comprises bottle 12 and closure 14. Bottle 12 includes bottle body 16 and ends in neck 18 which includes finish 20 at its upper end.

The first portion of neck 18 includes an inwardly extending circumscribing ridge 22 above which is disposed shoulder 24. Shoulder 24 leads radially outwardly to upwardly extended finish 20. Disposed on the inner walls of finish 20 are threads 26 or other fastener, which cooperate with fasteners on closure 14 when the container is closed, as will be discussed shortly.

Friction fit into the mouth 30 of bottle 12 defined by inwardly extending ridge 22 is fitment 28. Fitment 28 comprises circumferentially extending wall 32 which terminates at outwardly extending flange 34. Extending downwardly from wall 32 is downwardly sloping floor 36 which includes a product exit aperture 40. Ascending upwardly from floor 36 is pour spout 42. The outer surface of pour spout 42, the inner surface of circumscribing wall 32, the downwardly sloping floor 36 and the product exit aperture 40 combine to permit excess product retained by the fitment to flow back into the bottle 12.

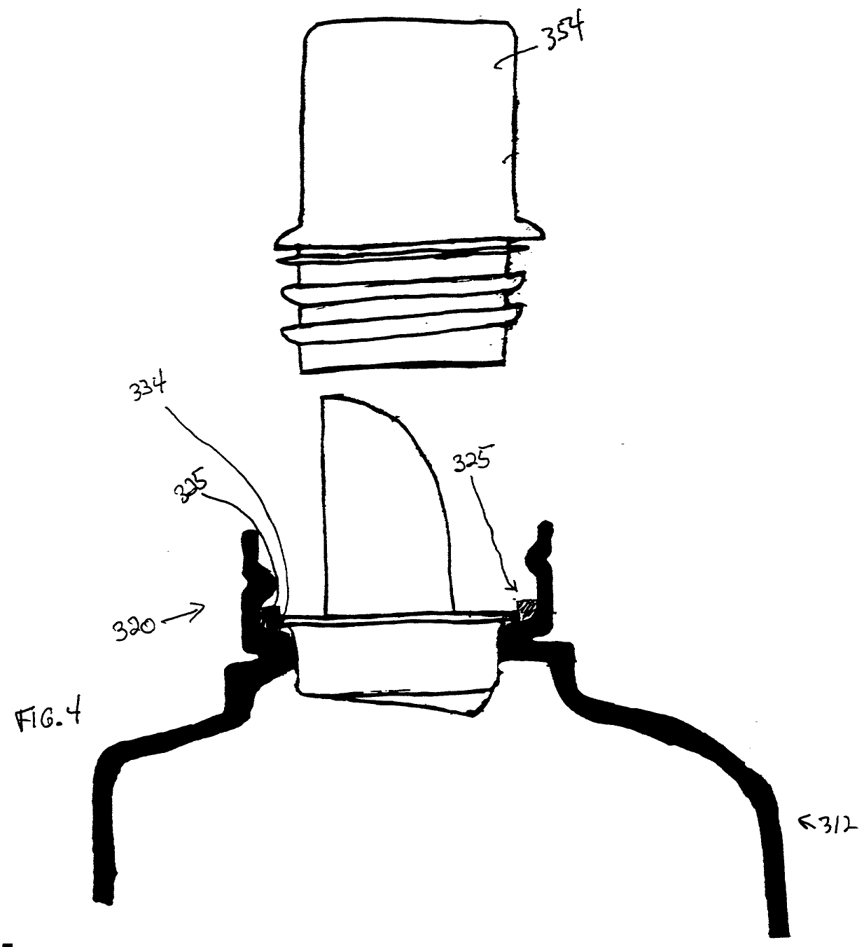

Closure 14 includes an open mouth 50 which may have an anti-drip lip, a downwardly depending skirt 52 leading to the mouth and a cylindrical body 54. The exterior of downwardly depending skirt 52 includes thread 56 or a plurality of threads, or one or more other fasteners such as lugs and grooves. Located above threads 56 is a flexible peripheral flange 60 which serves to aid in sealing when the closure is fastened to the finish of the bottle. Disposed above flexible flange 60 is annular shoulder 62 which is forced into contact with annular upper surface 64 of finish 20 when the closure is fastened to the bottle in its closed position. The upper surface of the finish may be beveled as seen for finish 120 in FIG. 3 (bevel 164). Closure 14 doubles as a measuring cup wherein product is poured into opening 50. Indicia such as fill lines may be engraved in the mold for determining the correct amount of product, if so desired.

Fitment 28 is preferably friction fit within inwardly extending ridge 22. Moreover, peripheral fitment flange 34 may rest atop shoulder 24 as at 70. Whether in fact flange 34 actually touches shoulder 24 will depend in part on the friction fit of the circumscribing wall 32 against inwardly extending ridge 22. In the event that flange 34 does not actually touch shoulder 24, it still tends to prevent the fitment from being pushed through the container opening 30 all the way into the bottle in the event that excess axial force is applied.

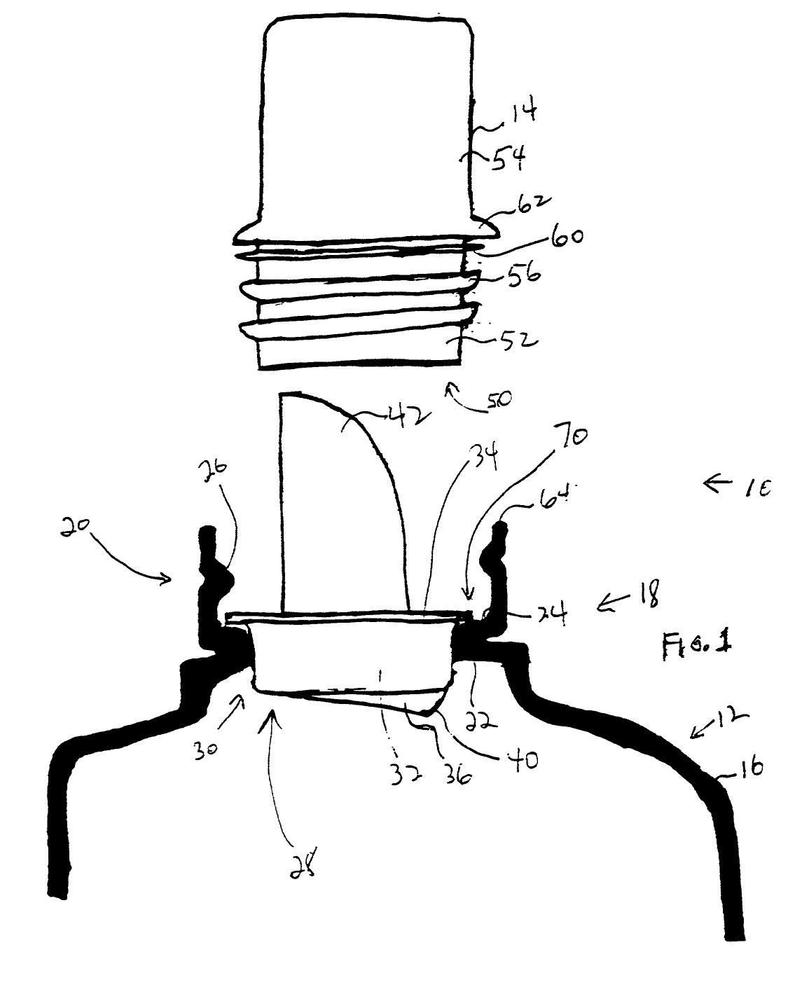

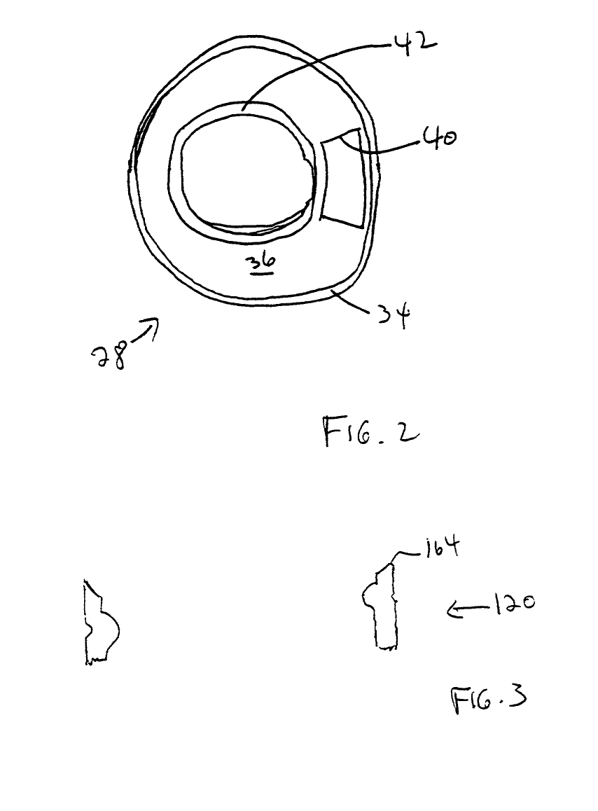

FIG. 4 shows an alternative embodiment of bottle 312 wherein finish 320 includes a wall 325 which is lateral to flange 334. Flange 334 is friction fit within wall 325. Preferably, the inside diameter of wall 325 is less than the inside diameter of the threads. However, as can be seen in both FIGS. 1 and 4, the retaining structure is lateral to and/or below the flange. The retaining structure is not above the flange so as to block or partially block the flange when the fitment is inserted or removed. In particular, the flange is not retained in a groove in the finish.

The bottle preferably is made of high density polyethylene, but also could be made of polypropylene, low density polyethylene, medium density polyethylene, polyvinyl chloride, or polyethylene terephthlate. Moreover, the bottle could be made with a monolayer wall structure, but preferably the bottle would be multilayer. For instance, a trilayer bottle could employ a natural, virgin resin, unpigmented inner layer, a pigmented virgin resin outer layer, and a middle layer combination of 25% post consumer recycled resin, in-process trim and virgin resin. Preferably, the bottle would have a handle and would be extrusion blow molded where an extruded parison would be captured and clamped within a bottle mold and injected air pressure would blow the melted plastic against the bottle mold walls, thereby forming the shape of the bottle.

Preferably the bottle is fabricated from a high density polyethylene. Another resin sold by U.S.I. under the designation 0.955 density, OI-388-2 is a suitable material.

The drain back fitment may be formed from a plastic such as low or high density polyethylene, polypropylene or PET. Or the polyethylene may be the product of a 50:50 blend of a high density resin and a low density resin. The high density resin can be U.S.I. LS 506 or a similar resin. The low density resin can be U.S.I. LS 208 or the like. Instead of a mix of resins, a high density polyethylene or a low density polyethylene such as U.S.I. 241 or even a stiffer material such as polypropylene may be used to form the fitment. Advantageously, the fitments may comprise recycled plastic such as PET. A PET fitment would permit easier pouring as the liquid could be seen through the spout. Other plastic resins having chemical and physical properties similar to the aforementioned resins can be used to form the plastic suitable for use in fabricating the drainback fitment.

In accordance with the invention, the spout is thermoformed and preferably trimmed. The spout may have a “horizontal” anti-drip lip naturally formed by the trimming operation. The thermoformed spout may have a large anti-rotational/stacking lug.

The closure may be formed of a harder material than that used in the drainback fitment. Preferably, the plastic material from which the closure is made is a homopolymer polypropylene such as that sold by Phillips Petroleum Company under the designation Phillips HLV 120-01. The closure also could be made of polypropylene copolymer.

If desired, the spout may be made with a shallow drainback slope and be designed to maximize “drain-out” and minimize product retainage.

The pour spout and preferably all of the fitment of the invention are preferably thermoformed.

The thermoforming operation includes heating up a sheet of plastic material to its softening point, and then drawing the material into a “female” mold via vacuum preferably using a “male” assist plug to help push the material into the mold.

The multicavity spout forms then would be trimmed to provide the dispensing orifice and drainback hole and also trimmed around the annular perimeter to release the spout from the sheet. Trimmed spouts would then be collated and placed into stacks for packing and shipment.

The thermoformed spout may be trimmed with a continuous opening from the top to the drainback hole or, particularly if the thermoformed spout is clear, there may only be a top opening to dispense the liquid and a separate bottom hole to drain back the liquid. This would simplify the trimming operation.

The thermoformed spout and/or fitment of the invention is preferably made of polyethylene terepthalate (PET). PET is preferred because it is transparent and clear and permits an unobstructed view. It is preferred that the fitment be sufficiently transparent so that the consumer can see the product through the fitment during pouring and measuring. Moreover, the inside of the measuring cup can be seen through the spout and this helps fill to the correct level. The thermoformed spout of the invention may also be made of polystyrene, LDPE, MDPE, PP, HDPE, PVC, or recycled green-tinted PET.

An important advantage of use of a thermoformed spout is that the part weight may be much lower with a thermoformed spout as described (4.3 grams versus 14.3 grams for our current spout). This is due not only to the thinner starting sheet material but the elimination of much of the outer wall on the thermoformed spout.

While the circumscribing fitment wall illustrated herein is an outer wall, it will be apparent that the circumscribing wall leading to the floor need not be an outer wall. That is, the circumscribing wall circumscribes the spout, but is not necessarily the outer boundary of the fitment.

If desired, the neck of the bottle may be tapered (narrower toward the container mouth), e.g. by reaming or beveling to facilitate insertion of the fitment. For example, the internal surface of ridge 11 may be beveled to narrow downwardly. Likewise, the internal diameter of the finish at the threads may be larger than the internal diameter at the fitment.

The spout may be made of a material that is softer, equal to or harder than the bottle resin material.

It should be understood, of course, that the specific forms of the invention herein illustrated and described are intended to be representative only, as certain changes may be made therein without departing from the clear teachings of the disclosure. Accordingly reference should be made to the following appended claims in determining the full scope of the invention.

What is claimed is:

1. A fitment formed by thermoforming comprising a circumscribing wall, a floor extending inwardly from a bottom of said wall, and a pour spout ascending from an inward portion of said floor.

2. The thermoformed fitment according to claim 1 further comprising a flange extending radially outwardly from an upper end of an outer wall of said fitment wall.

3. The fitment of claim 1 wherein said spout is frustoconical.

4. The fitment according to claim 2 wherein said outer wall is the circumscribing wall.

5. A bottle comprising a bottle body, a finish extending upwardly from said body and a thermoformed fitment received within said body, said fitment comprises a circumscribing wall, a floor extending inwardly from a bottom of said wall, and a pour spout ascending from an inward portion of said floor said spout being at least partially within said finish.

6. The bottle according to claim 5 wherein said finish includes internal fasteners.

7. The bottle according to claim 6 wherein said fasteners are screw threads.

8. The bottle according to claim 7 in combination with a closure having external screw threads mating with said internal screw threads.

9. The fitment of claim 1 wherein it is transparent.
